(19) United States
(12) Patent Application Publication
(10) Pub. No.: US 2004/0213704 A1
(43) Pub. Date: Oct. 28, 2004

(54) Ventilated incense burner with incense smoke visual interest

(76) Inventor: John Reed, Zuo (CN)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/421,476

(22) Filed: Apr. 23, 2003

(51) Int. Cl. B32B 5/02

(52) U.S. Cl. 422/126; 422/120; 422/123; 422/5

(57) ABSTRACT

An improved incense burner depicting a real or imaginary creature for providing smoke escaping from active areas of the creature (e.g., its nose or mouth) including a hollow enclosed container having an outer surface, at least the head of a real or mythical character formed on the outer surface of the container, a first grouping of vent holes for permitting external air to enter the interior of the container, and a second grouping of vent holes passing from inside the container to its outer surface for permitting incense-bearing smoke to escape therefrom.

### BACKGROUND OF THE INVENTION

The present invention relates to a unique incense burner in which ventilation substantially improves the performance of the device and makes it possible to provide visual interest in the form of incense smoke emanating from active areas of the incense burner.

Incense burners are widely available in various different shapes and forms. Currently available incense burners, however, do not provide any interest beyond the provision of a pleasant or fragrant odor. If the smoke escaping from an incense burner could provide visual interest in addition or the expected pleasant or fragrant odor, there would be an important contribution to the art of incense burners. The incense burner of the present invention comprises such a contribution to the art. It is a highly decorative device for efficiently burning incense which provides visual interest in the form of incense smoke emanating from active areas of a creature depicted on the outside of the device.

These and various other objects and other advantages of this invention will be apparent from the description which follows as well as the associated drawings and appended claims.

### SUMMARY OF THE INVENTION

The present invention comprises an improved incense burner depicting a real or mythical creature emitting or “breathing” smoke. The incense burner includes a hollow enclosed container having an outer surface with a two-dimensional or three-dimensional real or mythical creature depicted preferably in relief on the outer surface of the container. It also includes hidden vent holes strategically located in the container. These holes are in two groupings, a lower grouping of one or more holes to permit an air stream to enter the container, and an upper grouping of one or more holes to permit incense bearing smoke to escape from active areas of the creature such as its the nose, mouth, or ears.

In the embodiment illustrated below, an elongated container designed to burn incense sticks is described. In this embodiment, the container is provided with a removable plug for holding the incense stick within the inner cavity of the container so that its burning tip is at the stick end away from the plug. Other shapes of the container and other types of incense could, of course, be used.

The present invention is also directed to a method of providing a realistic looking smoke breathing creature comprising a hollow enclosed container with a three-dimensional real or mythical creature depicted in relief or in two-dimensional form on the outer surface of the container, and vent holes strategically located in the container. The vent holes preferably are hidden from view by features of the creature that project from the outer surface of the burner to block line-of-sight viewing thereof. According to the method, a source of incense smoke is burned within the container causing incense bearing smoke to escape from active areas of the creature depicted on the outer surface of the container such as its the nose and mouth, providing visual interest in addition or the expected pleasant or fragrant odor of the incense.

### BRIEF DESCRIPTION OF THE DRAWINGS

FIG. 1 is a perspective view of an incense burner in accordance with the present invention;

FIGS. 2 and 3 respectively are partial perspective views corresponding to FIG. 1 in which a plug is at rest in a receiving cavity near the top of the burner (FIG. 2) and in which the plug is shown removed from the cavity (FIG. 3);

FIG. 4 is a partial perspective view of the interior of the plug shown in FIGS. 2 and 3, with a lit incense stick mounted therein;

FIG. 5 is a partial perspective view of the top portion of the incense burner of FIG. 1 showing the plug with mounted and lit incense stick aligned with and about to be inserted into the receiving cavity;

FIG. 6 is a cutaway view of the top portion of the burner as depicted in FIG. 1, showing incense bearing smoke escaping from holes in the top of the burner; and

FIG. 7 is a perspective view of the incense burner, as depicted in FIG. 1, showing the entry of ventilating air and the exit of a stream of incense smoke.

### DESCRIPTION OF A PREFERRED EMBODIMENT OF THE INVENTION

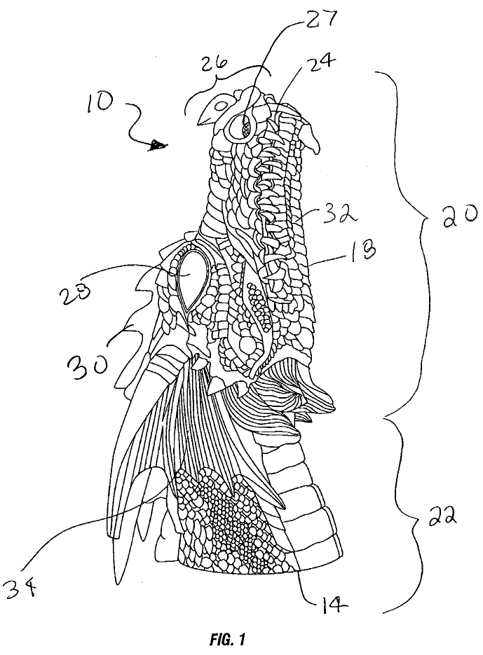

Referring now to FIG. 1, an incense burner 10 is depicted with the exterior of the incense burner configured to represent the head and a portion of the neck of an imaginary creature, in relief. While other designs could certainly be fashioned on the outer surface of the incense burner of the present invention, it is important for the purposes of the present invention that the outer configuration represent a real or imaginary creature with vent holes permitting incense smoke to escape from the creature in “active areas”. By “active areas”, I mean locations such as the nose of a dragon, from which the escape of incense smoke suggests a “living” smoke-producing creature.

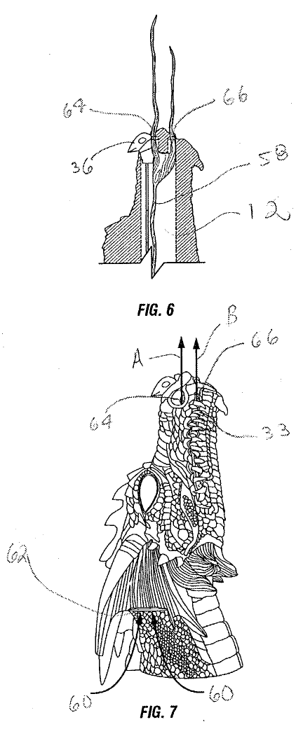

Incense burner 10 includes a hollow interior 12 (FIG. 6) with a flat base 12 for resting on a flat surface such a table top (not shown). The base is closed as is the entire vertical aspect of the device, with the exception of two groupings of vent holes that will be described in more detail below. In the illustrated embodiment, the outer surface of the incense burner has the structure and appearance, in relief, of the head 20 of a mythical creature 18. Creature 18 includes a neck portion 22, a mouth 24, a nose 26 with nostrils 27, eyes 28, crown 30, scales 32, teeth 33, and wings 34.

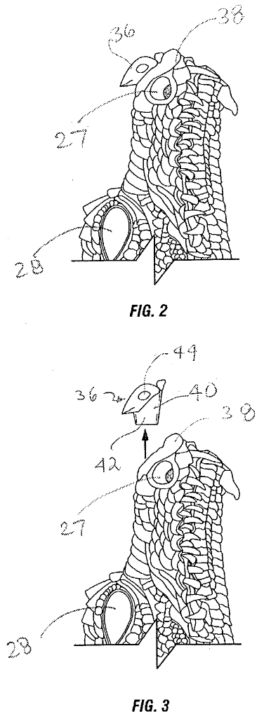

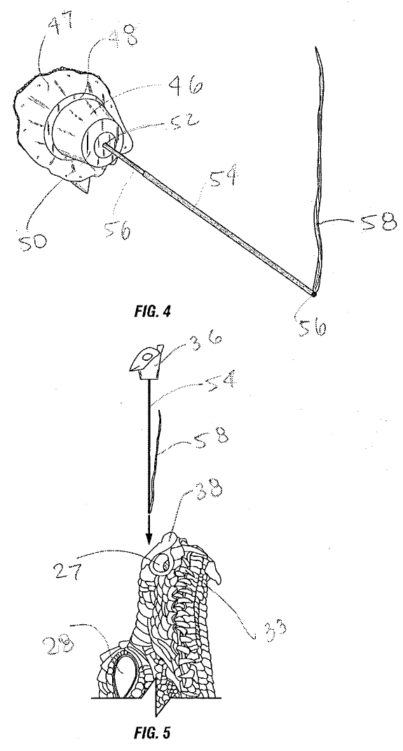

Turning now to FIGS. 2 and 3, a plug 36 is depicted, first at rest in a receiving cavity 38 in the burner (FIG. 2), and then removed from the cavity with its lower section 40 exposed (FIG. 3). In the incense burner depicted here, plug 36 depicts a portion of the nose of the mythical creature, with secondary nostrils 44.

As shown in FIG. 4, plug 36 includes a frusto-conical portion 46 which is dimensioned to sit within a corresponding frusto-conical aperture in receiving cavity 38. The frusto-conical portion projects from the back surface 47 of the plug, and includes a lip 48 circumscribing the base of the frusto-conical portion.

The bottom flat surface 50 of frusto-conical portion 34 has a blind circular hole 52 dimensioned to receive and return the round base 56 of an incense stick 54. In the illustrated embodiment, incense stick 54 has been lit and is throwing off from its tip 56 a stream of incense smoke 58. Once lit, incense stick 54 is passed through cavity 38 until plug 36 seats in the cavity.

As seen in FIG. 7, once the plug is emplaced, the incense stick continues to burn from its bottom upwardly in a stream of air 60 drawn through a hidden bottom grouping of vent holes 62 comprising in this embodiment two below wings 34, with the hidden left side of the burner identical to the shown right side. The stream of incoming air promotes burning of the incense and permits the incense-bearing smoke to escape from an upper grouping of vent holes 33, nostrils 27, and two vent holes 66 between teeth 33 of the creature, as depicted by arrows A and B.

Thus, in the present incense burner, a stream of incense-bearing smoke escapes from an upper set of hidden vent holes at the nostrils and mouth of the mythical creature, supplied with an air stream through a second set of hidden vent holes to thereby produce a realistic smoke-breathing creature.

While the present invention is described above in connection with a preferred embodiment, this embodiment is not intended to be exhaustive of limiting of the invention. Rather, the invention is intended to cover all alternatives, modifications and equivalents that may be within its sphere and scope, as defined by the appended claims.

What is claimed is:

1. An improved incense burner depicting a real or imaginary creature for providing incense smoke escaping from active areas of the creature comprising:
a hollow enclosed container having an outer surface;
at least the head of a real or mythical character formed on the outer surface of the container;
a first lower grouping of vent holes for permitting external air to enter the interior of the container; and
a second upper grouping of vent holes passing from inside the container to its outer surface for permitting incense-bearing smoke to escape therefrom.

2. The improved incense burner of claim 1 in which the real or mythical character is formed in relief on the outer surface of the container.

3. The improved incense burner of claim 1 in which the real or mythical character is depicted in two-dimensional form.

4. The improved incense burner of claim 1 in which the real or mythical character has a nose with nostrils and the second grouping of vent holes extends through the nostrils.

5. The improved incense burner of claim 1 in which the first grouping of vent holes comprises two or more holes.

6. The improved incense burner of claim 1 in which the second grouping of vent holes comprises two or more holes.

7. The improved incense burner of claim 1 in which the real or mythical character has a mouth and the second grouping of vent holes extends through the mouth.

8. The improved incense burner of claim 1 in which the real or mythical character is three-dimensional and at least the first grouping of holes is hidden from view by features of the creature that project therefrom.

9. The improved incense burner of claim 1 including means for mounting an incense stick in the elongated container.

10. The improved incense burner of claim 9 in which the mounting means includes means for holding the incense stick with its burning tip away from the holder.

11. The improved incense burner of claim 1 including a removable plug for holding an incense stick within the container.

12. The improved incense burner of claim 1 in which the mythical creature is a gargoyle-like creature.

13. The improved incense burner of claim 11 in which the mythical creature is a gargoyle-like creature and the plug comprises a portion of the head of the nose of the creature.

14. The improved incense burner of claim 1 in which the bottom grouping of holes is near the bottom of the container of the incense burner.

15. A method of providing a realistic looking smoke-breathing creature comprising:
providing a hollow enclosed container having an outer surface, a real or mythical character formed on the outer surface of the container, and a first grouping of vent holes located in the container to permit air to enter the container and a second grouping of vent holes permit smoke to escape from active areas of the mythical character; and
generating smoke within the container to be carried by air entering at the first grouping of vent holes through the second grouping of vent holes.

16. The improved method of claim 15 in which the real or mythical character has a nose with nostrils and the second grouping of vent holes extends through the nostrils.

17. The improved incense burner of claim 15 in which the real or mythical character has a mouth and the second grouping of vent holes extends through the mouth.

18. The method of claim 15 in which the real or mythical character is three-dimensional and at least the first grouping of holes is hidden from view by features of the creature that project therefrom.

19. The method of claim 15 in which the smoke is generated by a burning incense stick.
